(19) United States
(12) Patent Application Publication
(10) Pub. No.: US 2012/0069183 A1
(43) Pub. Date: Mar. 22, 2012

(54) VEHICLE DETECTION APPARATUS

(75) Inventors: Yasuhiro AOKI, Kawasaki-shi (JP); Toshio Sato, Yokohama-shi (JP); Yusuke Takahashi, Tama-shi (JP)

(73) Assignee: KABUSHIKI KAISHA TOSHIBA, Tokyo (JP)

(21) Appl. No.: 13/232,525

(22) Filed: Sep. 14, 2011

(30) Foreign Application Priority Data
Sep. 16, 2010 (JP) 2010-208539

(51) Int. Cl. H04N 7/18; G06K 9/00

(52) U.S. Cl. 348/148; 382/118; 382/105; 348/E07.085

(57) ABSTRACT

According to one embodiment, a vehicle detection apparatus includes a line segment extraction unit, candidate creation unit, evaluation unit, and specific part detection unit, and the line segment extraction unit extracts a plurality of line-segment components constituting an image of a vehicle from the image formed by photographing the vehicle. The candidate creation unit carries out polygonal approximation configured to create a closed loop by using a plurality of line-segment components to create a plurality of candidates for an area of a specific part of the vehicle. The evaluation unit carries out a plurality of different evaluations for each of the plurality of candidates. Further, the specific part detection unit detects one of the plurality of candidates as the specific part based on evaluation results of the evaluation unit.

### CROSS-REFERENCE TO RELATED APPLICATIONS

This application is based upon and claims the benefit of priority from prior Japanese Patent Application No. 2010-208539, filed Sep. 16, 2010, the entire contents of which are incorporated herein by reference.

### FIELD

Embodiments described herein relate generally to a vehicle detection apparatus used to detect a specific part of a vehicle such as an automobile or the like.

### BACKGROUND

As is generally known, a vehicle detection apparatus provided at, for example, a freeway tollgate detects the passage of a vehicle by a pole sensor. However, the shapes of vehicles are extremely diverse, the length from a distal end part of a vehicle to a specific part (for example, the windshield) thereof detected by the pole sensor differs depending on the vehicle, and hence it is difficult to detect the specific part of a vehicle by means of a pole sensor.

On the other hand, although there is a technique configured to detect a specific part of a vehicle by analyzing an image formed by photographing a passing vehicle, there is a problem that the installation requirements of the camera are critical.

In the conventional vehicle detection apparatus, there has been the problem of the critical camera installation requirements.

The invention makes it a task to solve the above problem, and makes it an object to provide a vehicle detection apparatus with a high degree of flexibility in camera setting, and capable of obtaining a high degree of detection accuracy.

### BRIEF DESCRIPTION OF THE DRAWINGS

FIG. 1 is a view showing the configuration of an electronic toll collection system to which a vehicle detection apparatus according to an embodiment is applied.

FIG. 2 is a circuit block diagram showing the configuration of the vehicle detection apparatus shown in FIG. 1.

FIG. 3 is a flowchart configured to explain an operation of the vehicle detection apparatus shown in FIG. 1 according to a first embodiment.

FIG. 4 is a view configured to explain area segmentation based on colors in the first embodiment.

FIG. 5 is a view configured to explain the concept of the area segmentation in the first embodiment.

FIG. 6 is a view configured to explain an operation of creating a closed loop in the first embodiment.

FIG. 7 is a flowchart configured to explain an operation of the vehicle detection apparatus shown in FIG. 1 according to a second embodiment.

FIG. 8 is a view configured to explain a detection operation of a characteristic part in a vehicle image in the second embodiment.

FIG. 9 is a flowchart configured to explain an operation of the vehicle detection apparatus shown in FIG. 1 according to a third embodiment.

FIG. 10 is a view configured to explain a detection operation of a characteristic part in a vehicle image in the third embodiment.

FIG. 11A is a view configured to explain a contour detection operation of a vehicle in the third embodiment.

FIG. 11B is a view configured to explain a contour detection operation of a vehicle in the third embodiment.

### DETAILED DESCRIPTION

In general, according to one embodiment, a vehicle detection apparatus includes a line segment extraction unit, candidate creation unit, evaluation unit, and specific part detection unit, and the line segment extraction unit extracts a plurality of line-segment components constituting an image of a vehicle from the image formed by photographing the vehicle. The candidate creation unit carries out polygonal approximation configured to create a closed loop by using a plurality of line-segment components to create a plurality of candidates for an area of a specific part of the vehicle. The evaluation unit carries out a plurality of different evaluations for each of the plurality of candidates. Further, the specific part detection unit detects one of the plurality of candidates as the specific part based on evaluation results of the evaluation unit.

### First Embodiment

Hereinafter, an embodiment will be described with reference to the drawings.

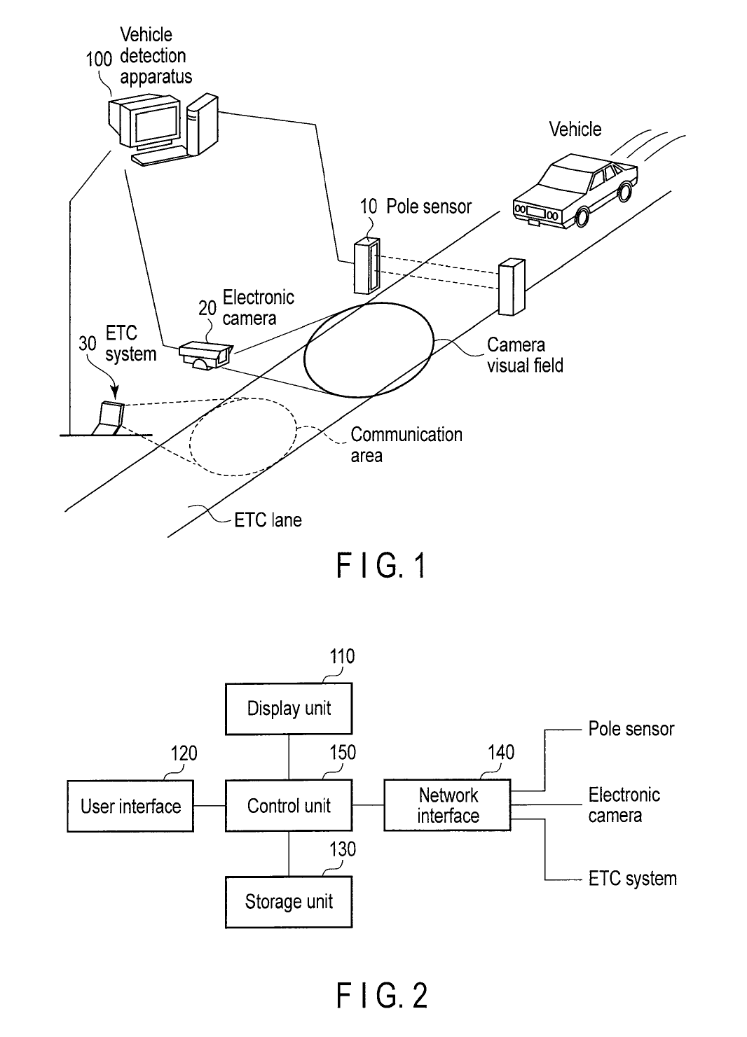

FIG. 1 is a view showing a system configuration example of a case where a vehicle detection apparatus 100 according to a first embodiment is applied to an electronic toll collection (ETC) system.

A pole sensor 10 is a sensor configured to detect a vehicle entering an ETC lane by using an optical sensor or a tread board, and notifies the vehicle detection apparatus 100 of a detection result.

An electronic camera 20 is a digital camera configured to produce a dynamic image at a preset frame rate, and configured to photograph a vehicle traveling in the ETC lane, and passing the pole sensor 10. That is, the electronic camera 20 takes a plurality of images for the vehicle traveling in the ETC lane. It should be noted that in the following description, a windshield is taken as an example of a specific part of a vehicle, and hence the electronic camera 20 is installed at a position at which a full view of a vehicle including at least a windshield of the vehicle can be photographed.

Further, in the image data obtained by the electronic camera 20, a time code indicating the shooting time is included. The devices and apparatuses shown in FIG. 1 including the electronic camera 20, vehicle detection apparatus 100, and other devices have synchronized time data items. It should be noted that if the electronic camera 20, vehicle detection apparatus 100, and other devices operate in synchronism with each other (if the vehicle detection apparatus 100, and other devices can recognize the shooting time of the image data of the electronic camera 20) by some method or other, the image data may not necessarily include the time code.

The ETC system 30 is a system configured to automatically collect a toll to be imposed on a vehicle traveling on a toll road such as a freeway, and carries out wireless communication with an onboard ETC device installed in the vehicle to acquire data identifying the passing vehicle. It should be noted that in general, an onboard ETC device is installed at a position in a vehicle at which at least an antenna configured to carry out wireless communication can visually be recognized through a windshield. Accordingly, it is possible to carry out highly accurate communication with the onboard ETC device by accurately specifying the position of the windshield.

The vehicle detection apparatus 100 is provided with a display unit 110, user interface 120, storage unit 130, network interface 140, and control unit 150.

The display unit 110 is a display device in which a liquid crystal display (LCD) or the like is used, and displays various data items including the operation status of the vehicle detection apparatus 100.

The user interface 120 is an interface configured to accept an instruction from the user of a keyboard, mouse, touch panel or the like.

The storage unit 130 is a device configured to store therein a control program and control data of the control unit 150, and uses one or a plurality of storage means including an HDD, RAM, ROM, flash memory, and the like.

The network interface 140 is connected to a network such as a LAN or the like, and communicates with the pole sensor 10, electronic camera 20, and ETC system 30 through the network.

The control unit 150 is provided with a microprocessor, is configured to operate in accordance with a control program stored in the storage unit 130 to control each unit of the vehicle detection apparatus 100 in a unifying manner, and is configured to detect a specific part of a vehicle previously incorporated into the control program from a photographed image of the electronic camera 20 to predict the passing time (passing time in the communication area of the ETC system 30) on the real space.

Next, an operation of the vehicle detection apparatus 100 having the above configuration will be described below.

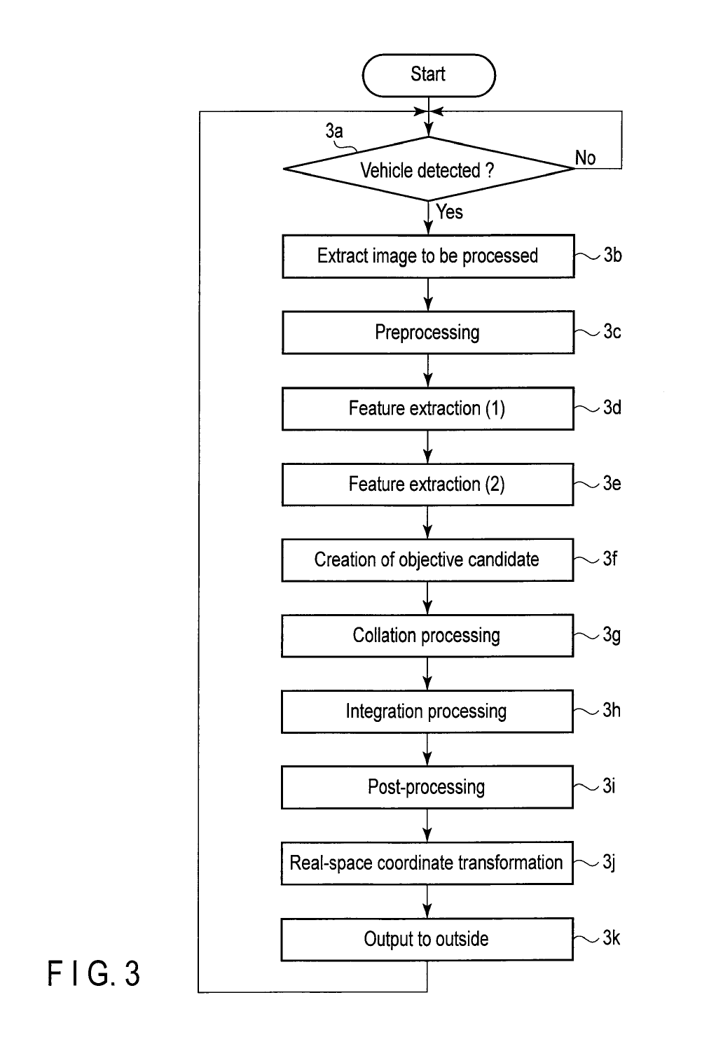

FIG. 3 is a flowchart configured to explain the operation of the vehicle detection apparatus 100, and when the power is turned on to operate the apparatus 100, the operation is repetitively executed until the power is turned off. It should be noted that this operation is realized by the control unit 150 operating in accordance with the control program or control data stored in the storage unit 130.

Further, prior to the start-up of the vehicle detection apparatus 100, the pole sensor 10 and the electronic camera 20 are also started. Thereby, the pole sensor 10 starts monitoring an entry of a vehicle into the ETC lane, and notifies the vehicle detection apparatus 100 of the detection results until the power is turned off. Further, the electronic camera 20 starts photographing at a predetermined frame rate, and transmits the produced image data to the vehicle detection apparatus 100 until the power is turned off.

First, in step 3a, the control unit 150 determines whether or not a vehicle has entered the ETC lane based on notification from the pole sensor 10 through the network interface 140. Here, when an entry of a vehicle is detected, the flow is shifted to step 3b and, on the other hand, when no entry of a vehicle can be detected, the flow is shifted again to step 3a, and monitoring of a vehicle entry is carried out.

In step 3b, the control unit 150 extracts image data of a frame photographed at the predetermined time from a plurality of image data items transmitted from the electronic camera 20 through the network interface 140, and shifts to step 3c. Hereinafter, the extracted image data is referred to as the image data to be processed. It should be noted that the predetermined time is determined in consideration of the positional relationship (installation distance) between the installation position of the pole sensor 10, and camera visual field (shooting range) of the electronic camera 20, assumed passing speed of a vehicle, and the like so that image data in which the specific part of the vehicle is included can be extracted.

In step 3c, the control unit 150 subjects the image data to be processed to preprocessing, and shifts to step 3d. It should be noted that as the specific nature of the preprocessing, noise removal is carried out for the purpose of improving the signal-to-noise ratio to sharpen the image or filtering is carried out in order to improve the contrast of the image.

Further, for the purpose of correction of the image, for example, touch-up or the like of an image distortion is carried out.

In step 3d, the control unit 150 applies a method such as a Hough transform to the image data to be processed which has been subjected to the preprocessing in step 3c to extract a plurality of line-segment components constituting the image of the vehicle from the image, and then shifts to step 3e.

As the specific extraction algorithm in which the windshield is assumed as the specific part, when the vehicle is photographed from above, extraction of line-segment components in eight directions based on the horizontal and vertical directions in the image is carried out.

Thereby, a large number of line segments including the boundary part of the windshield are extracted. Regarding the windshield, a part or the like around the wiper is often formed into a curved surface, and hence it is considered that it is difficult to extract the part by one line segment. Accordingly, in general, it is possible to approximate the shape of the windshield by carrying out extraction by means of a polygon or a broken line formed by combining a plurality of line segments. Further, for example, when a circle is approximated by using line segments, the circle is approximated by an inscribed regular octagon. In this case, although the error corresponds to a difference in area between the circle and inscribed regular octagon, the error is considered to be allowable as an error in the practical design.

It should be noted that a method such as a Hough transform may be applied to the image data to be processed, and image data of frames in front of and behind the image data to be processed to extract line-segment components from each image, and line-segment components at the predetermined time (shooting time of the image data to be processed) may be obtained by carrying out a forecast of geometric variation concomitant with the movement of the vehicle based on these line-segment components which are continuous in terms of time. As described above, it is possible to improve the extraction accuracy by using image data items of a plurality of frames.

In step 3e, the control unit 150 subjects the image data to be processed which has been subjected to the preprocessing in step 3c to sharpening processing configured to improve the resolution, thereafter applies a method such as a Hough transform to the image data to be processed to extract a plurality of line-segment components constituting the image of the vehicle from the image, and then shifts to step 3f.

It should be noted that in step 3e, for example, when the dynamic range of the electronic camera 20 is large (for example, 10 bits), the dynamic range may be divided into scope divisions (1 to 255, 256 to 512, 513 to 768, and 768 to 1024) of a multistage range and, a method such as a Hough transform may be applied to each scope division to thereby extract line-segment components from the image.

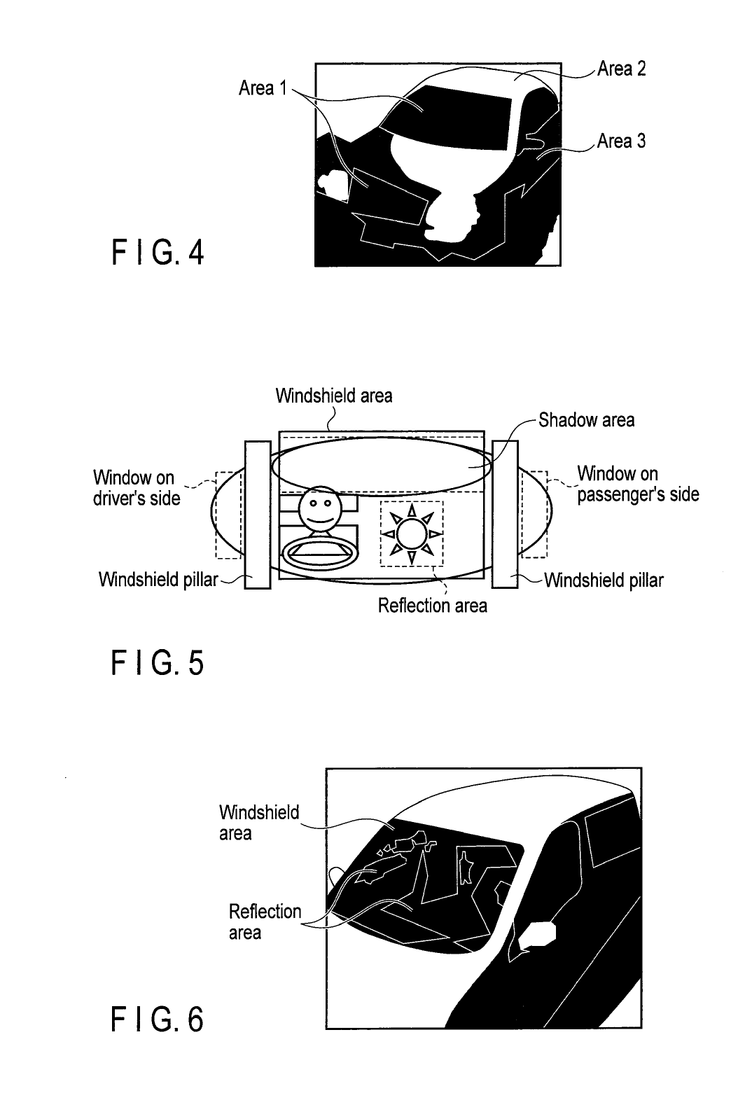

Further, in step 3d, and step 3e, although it has been described that the line-segment components are extracted by using a method such as a Hough transform, when color data is included in the image data to be processed, an image based on the image to be processed may be divided into areas of each of similar colors based on the color data as shown in, for example, FIG. 4, and a boundary between the areas may be extracted as line-segment components. By such a method too, it is possible to detect a boundary between the windshield and a part of the vehicle other than the windshield as line-segment components.

In step 3f, the control unit 150 carries out polygonal approximation configured to create a closed loop by using the line-segment components extracted in step 3d and step 3e to create candidates for the windshield area, and then shifts to step 3g.

As factors extracted from the image by the polygonal approximation, there are the windshield area, shadow area reflected in the windshield, reflection area in which the sun is reflected, windshield pillars each of which is a part of the vehicle, and windows of the driver's seat and passenger's seat as shown in FIG. 5. Actually, closed loops of complicated shapes are created by a plurality of line segments as shown in FIG. 6.

Although the windshield area can be approximated by a rectangle if the windshield has the simplest shape, the windshield area is approximated by a shape including curved lines depending on the shape of the windshield. Further, even when the shape of the windshield is simple, if the photographing is carried out from the side, a depth occurs on the right and left of the windshield to thereby cause asymmetry.

Further, at this point of time, although it is unknown which line-segment components constitute a part of the windshield area, the optimum solution exists in the combination of the closed loops into which the line-segment components expressing the boundary between the windshield and vehicle body are incorporated by the polygonal approximation. Accordingly, in step 3f, evaluation is carried out with respect to a plurality of closed loops created by the polygonal approximation by using an evaluation function, and the candidates are narrowed down to those accurately approximating the windshield area.

It should be noted that actually, there are parts in which the curvature is high or the contrast is insufficient, and it is conceivable that there are candidates in which a line segment remains partially lost. Accordingly, after supplementarily approximating the lost part by a line segment, the aforementioned evaluation may be carried out. For example, there is a case where one of the windshield pillars is hidden behind the windshield depending on the shooting angle and, in such a case, line-segment supplementation is carried out for the windshield end part on the hidden windshield pillar side to thereby complete the closed loop.

Further, various patterns of the windshield pillar are stored in advance in the storage unit 130, and a plurality of candidates for the windshield area are stored therein in association with the patterns. Further, in step 3f, a closed loop similar to the windshield pillar may be detected based on polygonal approximation, the windshield pillar may be detected by pattern matching between the detected closed loop and data stored in the storage unit 130, and a candidate for the windshield area associated with the detected windshield pillar may be obtained.

In step 3g, the control unit 150 carries out a plurality of different evaluations of the candidates for the windshield area obtained in step 3f, obtains a total value of a score of each evaluation, and then shifts to step 3h.

As the methods of the plurality of evaluations, (1) giving a score in consideration of a position, size, and the like of the windshield on the image, (2) giving a score based on luminance distribution around line segments constituting the windshield area, (3) giving a score in accordance with the degree of matching of the candidate with a template stored in advance in the storage unit 130, and the like are conceivable. Although it is conceivable that a polygon may appear in the windshield area because of, for example, the influence of reflection or a shadow, a low score is given to the polygon by above method 1 or 3.

In step 3h, the control unit 150 selects the optimum windshield area from the total values obtained in step 3g, and shifts to step 3i.

In step 3i, the control unit 150 inspects the positional relationship between the windshield area selected in step 3h, and front mask part (light, grill, and license plate) included in the image data to be processed to confirm whether or not there is any discrepancy (for example, misalignment between the windshield area and front mask part in the lateral direction is large). When there is no discrepancy, the control unit 150 shifts to step 3j. On the other hand, when there is a discrepancy, an identical inspection is carried out on a windshield area having the second highest total score value. It should be noted that the position of the front mask part of the vehicle is obtained by pattern matching of the elements constituting the front mask part.

In step 3j, the control unit 150 executes coordinate transformation processing configured to specify the coordinates (position) of the windshield on the real space on the ETC lane based on the shooting time of the image data to be processed, and position of the windshield area on the image of the image data to be processed, and then shifts to step 3k.

In step 3k, the control unit 150 notifies the ETC system 30 of the coordinates (position) of the windshield specified in step 3j through the network interface 140, and then shifts to step 3a . Upon receipt of the notification of the coordinates (position) of the windshield, the ETC system 30 carries out transmission/reception of a wireless signal at timing at which the windshield on which an antenna of the onboard ETC device is installed is directed to the ETC system 30 in consideration of the coordinates (position) of the windshield, assumed passing speed of the vehicle, and the like.

As described above, in the vehicle detection apparatus having the aforementioned configuration, a plurality of line-segment components constituting the image of the vehicle are extracted from the image data obtained by photographing the vehicle (steps 3d and 3e), polygonal approximation of creating a closed loop is carried out by using these line-segment components to create a plurality of candidates for an area of a specific part (for example, the windshield) of the vehicle (step 3f), and a plurality of different evaluations are carried out for these candidates to specify the most probable area of the specific part of the vehicle (steps 3g and 3h).

Therefore, according to the vehicle detection apparatus configured as described above, if the specific part of the objective vehicle is included in the image, the specific part can be detected by image analysis, and hence the degree of flexibility in camera setting is high, and a high degree of detection accuracy can be obtained.

### Second Embodiment

Next, a second embodiment will be described below. It should be noted that the second embodiment is apparently identical to the first embodiment shown in FIGS. 1 and 2, and hence a description of the configuration thereof will be omitted. Further, like the first embodiment, a case where a vehicle detection apparatus according to the second embodiment is applied to an ETC is exemplified. The second embodiment differs from the first embodiment in the point that a control program of a vehicle detection apparatus 100 is different. Accordingly, an operation of the vehicle detection apparatus 100 according to the second embodiment will be described below.

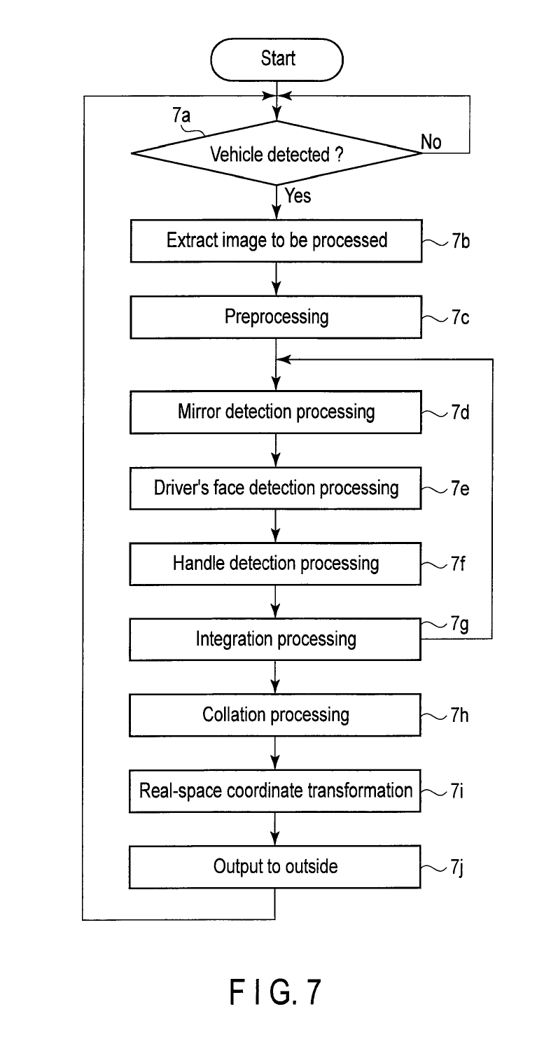

FIG. 7 is a flowchart configured to explain the operation of the vehicle detection apparatus 100 according to the second embodiment, and when the power is turned on to operate the apparatus 100, the operation is repetitively executed until the power is turned off. It should be noted that this operation is realized by a control unit 150 operating in accordance with the control program or control data stored in a storage unit 130.

Further, prior to the start-up of the vehicle detection apparatus 100, a pole sensor 10 and an electronic camera 20 are also started. Thereby, the pole sensor 10 starts monitoring an entry of a vehicle into an ETC lane, and notifies the vehicle detection apparatus 100 of the detection results until the power is turned off. Further, the electronic camera 20 starts photographing at a predetermined frame rate, and transmits the produced image data to the vehicle detection apparatus 100 until the power is turned off.

First, in step 7a, the control unit 150 determines whether or not a vehicle has entered the ETC lane based on notification from the pole sensor 10 through a network interface 140. Here, when an entry of a vehicle is detected, the flow is shifted to step 7b and, on the other hand, when no entry of a vehicle can be detected, the flow is shifted again to step 7a, and monitoring of a vehicle entry is carried out.

In step 7b, the control unit 150 extracts image data of a frame photographed at the predetermined time from a plurality of image data items transmitted from the electronic camera 20 through the network interface 140, and shifts to step 7c. Hereinafter, the extracted image data is referred to as the image data to be processed. It should be noted that the predetermined time is determined in consideration of the positional relationship (installation distance) between the installation position of the pole sensor 10, and camera visual field (shooting range) of the electronic camera 20, assumed passing speed of a vehicle, and the like so that image data in which a specific part of the vehicle is included can be extracted.

In step 7c, the control unit 150 subjects the image data to be processed to preprocessing, and shifts to step 7d. It should be noted that as the specific nature of the preprocessing, noise removal is carried out for the purpose of improving the signal-to-noise ratio to sharpen the image or filtering is carried out in order to improve the contrast of the image. Further, for the purpose of correction of the image, for example, touch-up or the like of an image distortion is carried out.

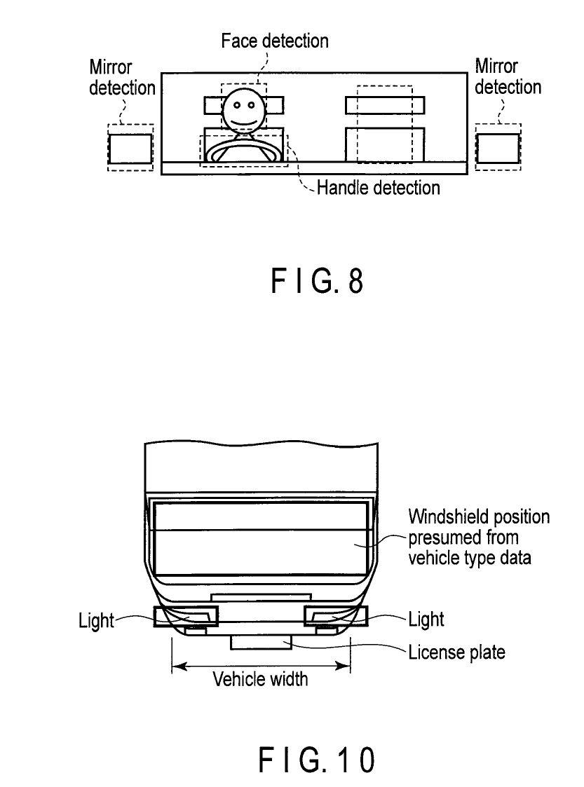

In step 7d, as shown in FIG. 8, the control unit 150 subjects the image of the image data to be processed which has been subjected to the preprocessing in step 7c to pattern match processing configured to search for a part coincident with a pattern formed by combining shapes and arrangement states of door mirrors of various vehicles, and prepared in advance in the storage unit 130 to detect left door mirror data dₘₗ (cx, cy, s), and right door mirror data dₘᵣ (cx, cy, s) based on the most coincident pattern, and then shifts to step 7e. It should be noted that cx indicates an x coordinate on the image based on the image data to be processed, cy indicates a y coordinate of the image, and s indicates the size.

In step 7e, as shown in FIG. 8, the control unit 150 subjects the image of the image data to be processed which has been subjected to the preprocessing in step 7c to pattern match processing configured to search for parts coincident with various face patterns prepared in advance in the storage unit 130 to detect face data d_{f} (cx, cy, s) based on the most coincident pattern, and then shifts to step 7f. It should be noted that cx indicates an x coordinate on the image based on the image data to be processed, cy indicates a y coordinate of the image, and s indicates the size.

In step 7f, as shown in FIG. 8, the control unit 150 subjects the image of the image data to be processed which has been subjected to the preprocessing in step 7c to pattern match processing configured to search for parts coincident with shape patterns of various handles prepared in advance in the storage unit 130 to detect handle data dₕ (cx, cy, s) based on the most coincident pattern, and then shifts to step 7g. It should be noted that cx indicates an x coordinate on the image based on the image data to be processed, cy indicates a y coordinate of the image, and s indicates the size.

In step 7g, the control unit 150 determines whether or not there is any discrepancy in the arrangement and size of the left door mirror, right door mirror, face, and handle based on the left door mirror data dₘₗ (cx, cy, s), right door mirror data dₘᵣ (cx, cy, s), face data d_{f} (cx, cy, s), and handle data dₕ (cx, cy, s) and, when there is no discrepancy, the control unit 150 shifts to step 7h. It should be noted that in a general vehicle, a driver's face and handle exist between the left door mirror and right door mirror, coordinates of the face and handle in the vertical direction exist in a predetermined range, and the face exists above the handle. An event contradictory to such arrangement is called a discrepancy. Besides, it is detected, in consideration of the size or the like, whether or not there is any discrepancy. On the other hand, when there is a discrepancy, the flow is shifted to step 7d, and a combination in which at least one of the door mirrors, face, and handle is changed is detected.

In step 7h, the control unit 150 extracts the optimum pattern from the patterns of the windshield prepared in advance in the storage unit 130 based on the left door mirror data dₘₗ (cx, cy, s), right door mirror data dₘᵣ (cx, cy, s), face data d_{f} (cx, cy, s), and handle data dₕ (cx, cy, s), and specifies a windshield area on the image based on the image data to be processed, and then shifts to step 7i.

In step 7i, the control unit 150 executes coordinate transformation processing configured to specify the coordinates (position) of the windshield on the real space on the ETC lane based on the shooting time of the image data to be processed, and position of the windshield area on the image of the image data to be processed, and then shifts to step 7j.

In step 7j, the control unit 150 notifies the ETC system 30 of the coordinates (position) of the windshield specified in step 7i through the network interface 140, and then shifts to step 7a. Upon receipt of the notification of the coordinates (position) of the windshield, the ETC system 30 carries out transmission/reception of a wireless signal at timing at which the windshield on which an antenna of the onboard ETC device is installed is directed to the ETC system 30 in consideration of the coordinates (position) of the windshield, assumed passing speed of the vehicle, and the like.

As described above, in the vehicle detection apparatus having the aforementioned configuration, positions and sizes of the mirrors, face, and handle are detected from the image data obtained by photographing the driver's seat and vicinity thereof (steps 7d, 7e, and 7f), then it is confirmed that there is no discrepancy in these data items (step 7g) and, thereafter an area of the specific part (windshield) of the vehicle on the image based on the image data is specified on the basis of the above data items (step 7h).

Therefore, according to the vehicle detection apparatus configured as described above, if the part around the driver's seat of the objective vehicle is included in the image, the specific part can be detected by image analysis, and hence the degree of flexibility in camera setting is high, and a high degree of detection accuracy can be obtained.

It should be noted that in the above second embodiment, although the description has been given on the assumption that the driver's face can be recognized, the description is not limited to this, and the upper half part of the body or the arm of the driver may be subjected to the pattern match processing to thereby specify the position thereof.

### Third Embodiment

Next, a third embodiment will be described below. It should be noted that the third embodiment is apparently identical to the first embodiment shown in FIG. 1 and FIG. 2, and hence a description of the configuration thereof will be omitted. Further, like the first embodiment, a case where a vehicle detection apparatus according to the third embodiment is applied to an ETC is exemplified. The third embodiment differs from the first embodiment in the point that a control program of a vehicle detection apparatus 100 is different. Accordingly, an operation of the vehicle detection apparatus 100 according to the third embodiment will be described below.

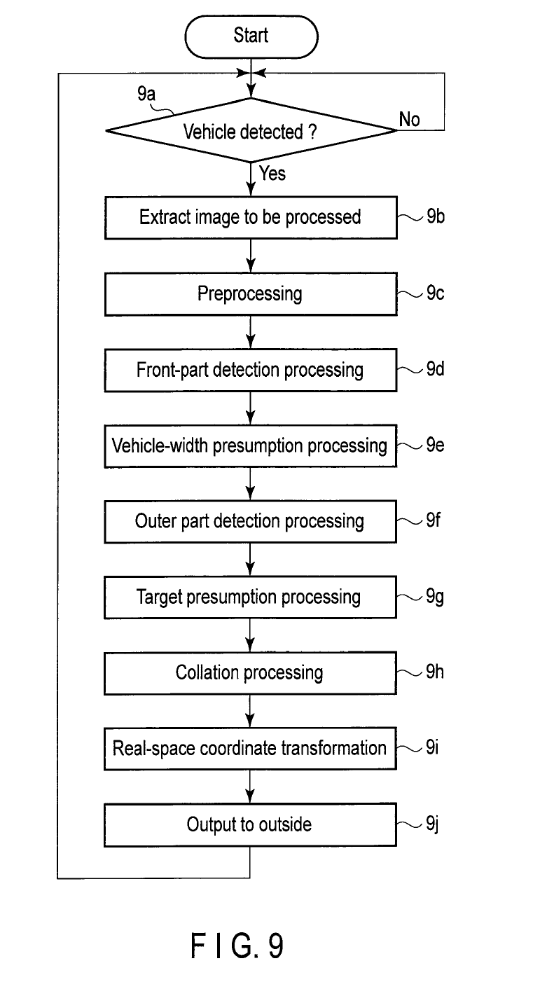

FIG. 9 is a flowchart configured to explain the operation of the vehicle detection apparatus 100 according to the third embodiment, and when the power is turned on to operate the apparatus 100, the operation is repetitively executed until the power is turned off. It should be noted that this operation is realized by a control unit 150 operating in accordance with the control program or control data stored in a storage unit 130.

Further, prior to the start-up of the vehicle detection apparatus 100, a pole sensor 10 and an electronic camera 20 are also started. Thereby, the pole sensor 10 starts monitoring an entry of a vehicle into an ETC lane, and notifies the vehicle detection apparatus 100 of the detection results until the power is turned off. Further, the electronic camera 20 starts photographing at a predetermined frame rate, and transmits the produced image data to the vehicle detection apparatus 100 until the power is turned off.

First, in step 9a, the control unit 150 determines whether or not a vehicle has entered the ETC lane based on notification from the pole sensor 10 through a network interface 140. Here, when an entry of a vehicle is detected, the flow is shifted to step 9b and, on the other hand, when no entry of a vehicle can be detected, the flow is shifted again to step 9a, and monitoring of a vehicle entry is carried out.

In step 9b, the control unit 150 extracts image data of a frame photographed at the predetermined time from a plurality of image data items transmitted from the electronic camera 20 through the network interface 140, and shifts to step 9c. Hereinafter, the extracted image data is referred to as the image data to be processed. It should be noted that the predetermined time is determined in consideration of the positional relationship (installation distance) between the installation position of the pole sensor 10, and camera visual field (shooting range) of the electronic camera 20, assumed passing speed of a vehicle, and the like so that image data in which a specific part of the vehicle is included can be extracted.

In step 9c, the control unit 150 subjects the image data to be processed to preprocessing, and shifts to step 9d. It should be noted that as the specific nature of the preprocessing, noise removal is carried out for the purpose of improving the signal-to-noise ratio to sharpen the image or filtering is carried out in order to improve the contrast of the image. Further, for the purpose of correction of the image, for example, touch-up or the like of an image distortion is carried out.

In step 9d, as shown in FIG. 10, the control unit 150 subjects the image of the image data to be processed which has been subjected to the preprocessing in step 9c to labeling processing or the like to extract areas of the headlights of the vehicle, and extract a rectangular shape similar to a license plate from a range presumed from the positions of the headlights, and then shifts to step 9e. In general, a license plate exists at a center of a part between right and left headlights, and below a line connecting the headlights. Positions of the right and left headlights, and license plate are treated as front-part data.

It should be noted that unevenness data indicating unevenness around the headlights, and license plate existing in a different manner for each vehicle type is stored in advance in the storage unit 130 as patterns, and front-part data (positions of the right and left headlights, and license plate) about each vehicle type is stored therein. Further, in step 9d, in the image of the image data to be processed, the unevenness existing around the headlights, and license plate may be subjected to pattern matching configured to compare the unevenness with the aforementioned unevenness data to thereby specify a vehicle type, and detect front-part data about the specified vehicle type.

In step 9e, the control unit 150 presumes a forward projection width (or distinction between a large-sized vehicle, medium-sized vehicle, and small-sized vehicle) of the vehicle from the data about the positions of the right and left headlights, and distance between the headlights included in the front-part data detected in step 9d, and then shifts to step 9f.

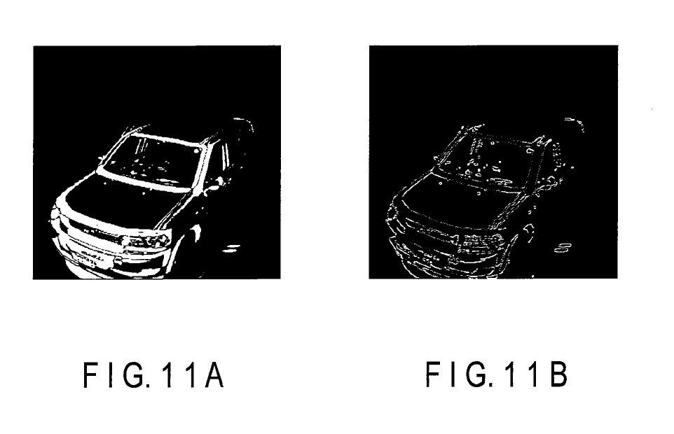

In step 9f, the control unit 150 detects differences between image data items of consecutive frames including the image data to be processed which has been subjected to the preprocessing in step 9c, separates the detected differences from the background (see FIG. 11A), accumulates the differences on one image to thereby detect the contour of the vehicle (see FIG. 11B), then presumes the height (vehicle height) of the vehicle, and inclination of the windshield based on the detected contour of the vehicle, and then shifts to step 9g.

In step 9g, the control unit 150 presumes a range into which the windshield can fit based on the front-part data obtained in step 9d, forward projection width (or distinction between a large-sized vehicle, medium-sized vehicle, and small-sized vehicle) of the vehicle obtained in step 9e, and height (vehicle height) of the vehicle, and inclination of the windshield obtained in step 9f, and then shifts to step 9h.

In step 9h, the control unit 150 refers to external-shape models of various windshields prepared in advance in the storage unit 130 to confirm whether or not an external-shape model suited to the range presumed in step 9g exists (i.e., whether or not the presumption of the windshield existence range is correct) and, when the external-shape model exists, shifts to step 9i. On the other hand, when the external-shape model does not exist, an error message is output to the display unit 110.

In step 9i, the control unit 150 executes coordinate transformation processing configured to specify the coordinates (position) of the windshield on the real space on the ETC lane based on the shooting time of the image data to be processed, and range presumed in step 9i, and then shifts to step 9j.

In step 9j, the control unit 150 notifies the ETC system 30 of the coordinates (position) of the windshield specified in step 9i through the network interface 140, and then shifts to step 9a. Upon receipt of the notification of the coordinates (position) of the windshield, the ETC system 30 carries out transmission/reception of a wireless signal at timing at which the windshield on which an antenna of the onboard ETC device is installed is directed to the ETC system 30 in consideration of the coordinates (position) of the windshield, assumed passing speed of the vehicle, and the like.

As described above, in the vehicle detection apparatus having the aforementioned configuration, the headlights and license plate are detected from the image data obtained by photographing the front part of the vehicle (step 9d), the vehicle width is presumed from the data items about the front part (step 9e), the contour of the vehicle is detected from image data items of a plurality of consecutive frames (step 9f), and the range into which the windshield can fit is presumed from the vehicle width and contour thereof (steps 9g and 9h).

Therefore, according to the vehicle detection apparatus having the aforementioned configuration, if the front part of the objective vehicle is included in the image, the position of the specific part can be detected (presumed) by image analysis, and hence the degree of flexibility in camera setting is high, and a high degree of detection accuracy can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vehicle detection apparatus comprising:
a line segment extraction unit configured to extract a plurality of line-segment components constituting an image of a vehicle from an image formed by photographing the vehicle;
a candidate creation unit configured to create a plurality of candidates for an area of a specific part of the vehicle by carrying out polygonal approximation configured to create a closed loop by using the plurality of line-segment components;
an evaluation unit configured to carry out a plurality of different evaluations for each of the plurality of candidates; and
a specific part detection unit configured to detect one of the plurality of candidates as the specific part based on evaluation results of the evaluation unit.

2. The apparatus according to claim 1, wherein
the line segment extraction unit divides the image formed by photographing the vehicle into areas of each identical color based on data of the image, and extracts boundaries between the areas as line-segment components.

3. The apparatus according to claim 1, wherein
the line segment extraction unit extracts a plurality of line-segment components constituting the image of the vehicle from each of a plurality of images formed by photographing the vehicle, and arranged consecutively in terms of time, and carries out a forecast of geometric variation concomitant with the movement of the vehicle based on these line-segment components arranged consecutively in terms of time to thereby extract a plurality of line-segment components constituting the image of the vehicle.

4. The apparatus according to claim 1, wherein
the candidate creation unit comprises
a storage unit configured to store a plurality of patterns indicating shapes of parts close to the specific part of the vehicle, and store a plurality of candidates for the specific part associated with the patterns,
a pattern detection unit configured to detect a pattern similar to the part close to the specific part from the storage unit by carrying out polygonal approximation configured to create a closed loop by using the plurality of line-segment components, and
a candidate detection unit configured to detect a plurality of candidates for the specific part associated with the patterns detected by the pattern detection unit from the storage unit.

5. The apparatus according to claim 1, wherein
the candidate creation unit creates a plurality of candidates for the area of the specific part of the vehicle by carrying out polygonal approximation configured to create a closed loop by supplementing the plurality of line-segment components.

6. The apparatus according to claim 1, further comprising:
a coordinate detection unit configured to obtain, based on the shooting time, and the shooting position of an image used by the specific part detection unit to obtain a detection result, and a position detected by the specific part detection unit, coordinates of the position on the real space.

7. A vehicle detection apparatus comprising:
a mirror detection unit configured to detect right and left side mirrors from an image formed by photographing a vehicle;
a face detection unit configured to detect a face of a driver from the image;
a handle detection unit configured to detect a handle from the image; and
a specific part detection unit configured to detect a position of a windshield in the image based on a detection result of each of the mirror detection unit, the face detection unit, and the handle detection unit.

8. The apparatus according to claim 7, further comprising a coordinate detection unit configured to obtain, based on the shooting time, and the shooting position of an image used by the specific part detection unit to obtain a detection result, and a position detected by the specific part detection unit, coordinates of the position on the real space.

9. A vehicle detection apparatus comprising:
a headlight detection unit configured to detect right and left headlights from an image formed by photographing a vehicle;
a license plate detection unit configured to detect a license plate from the image;
a width presumption unit configured to presume a width of the vehicle based on a detection result of each of the headlight detection unit, and the license plate detection unit;
a contour detection unit configured to detect a contour of the vehicle from a plurality of images which are formed by photographing the vehicle and include the image by extracting a boundary between the vehicle and the background; and
a specific part detection unit configured to detect a position of a windshield in the image based on the width presumed by the width presumption unit, and the contour detected by the contour detection unit.

10. The apparatus according to claim 9, further comprising a coordinate detection unit configured to obtain, based on the shooting time, and the shooting position of an image used by the specific part detection unit to obtain a detection result, and a position detected by the specific part detection unit, coordinates of the position on the real space.
